(19) United States
(12) Patent Application Publication
(10) Pub. No.: US 2009/0167963 A1
(43) Pub. Date: Jul. 2, 2009

(54) PROJECTION DISPLAY APPARATUS USING MICROLENS ARRAY AND MICROMIRROR ARRAY

(75) Inventors: O-Deuk Kwon, Daegu (KR); Koeng Su Lim, Daejeon (KR); Joon-Yong Choi, Jinju-si (KR); Dae-Hyun Kim, Daejeon (KR); Jun-Bo Yoon, Daejeon (KR); Jin-Wan Jeon, Daegu (KR)

Correspondence Address: The Belles Group, P.C., 1518 Walnut Street, Suite 1706, Philadephia, PA, 19102, US

(73) Assignee: KOREA ADVANCED INSTITUTE OF SCIENCE & TECHNOLOGY, Daejeon (KR)

(21) Appl. No.: 11/994,816

(22) PCT Filed: Jun. 26, 2006
(86) PCT No.: PCT/KR2006/002449

§ 371 Date: Dec. 22, 2008

(30) Foreign Application Priority Data
Jul. 4, 2005 (KR) 10-2005-0059825

(51) Int. Cl. H04N 9/31

(52) U.S. Cl. 348/744; 348/E09.025

(57) ABSTRACT

A projection display apparatus using a microlens array and a micromirror array comprises a substrate, multiple micromirror arrays and multiple microlens arrays. The substrate is disposed apart with a predetermined distance from a light source. The multiple micromirror arrays are disposed over the substrate to be assembled together to have a predetermined incidence angle with respect to the incident rays. The multiple microlens arrays are configured to correspond to the micromirror arrays. More specifically, a first microlens array is disposed in a predetermined region between the light source and the substrate and comprises multiple microlenses. A second microlens array is disposed in a light path of reflection rays reflected from the micromirrors.

### TECHNICAL FIELD

The present invention relates to a projection display apparatus using a micromirror array.

### BACKGROUND ART

FIG. 1 illustrates a simplified diagram of a typical projection display apparatus using a micromirror array.

As illustrated in FIG. 1, the typical projection display apparatus using the micromirror array comprises an incidence lens 1, a micromirror array 3, and a projection lens 6. The incidence lens 1 projects incident rays 2, and the micromirror array 3 reflects the incident rays 2 to a predetermined angle. The projection lens 6 projects reflection rays 5 reflected from the micromirror array 3 onto a screen.

The micromirror array 3 is disposed on a substrate 4 and, reflects the incident rays 2 that have projected through the incidence lens 1 and makes an image be displayed on the screen through the projection lens 6. The micromirror array 3 comprises multiple micromirrors, each corresponding to one pixel projected onto the screen. Adjusting an operation angle of the individual micromirror allows an adjustment of a reflection angle of the corresponding incident ray 2, so that the direction of the reflection rays 5 can be changed.

However, when each of the micromirrors of the micromirror array 3 is arranged in a predetermined operation angle, some of the incident ray 2 projected by the incident lens 1 can not be reflected because of spaces 9 between the individual micromirrors, and thus be lost. Therefore, those portions corresponding to the spaces 9 between the individual micromirrors are often displayed in dark colors on the screen. Also, a scattering effect usually occurring around edge portions of the micromirrors causes the light loss.

The light loss may become one factor that lowers a contrast ratio of the image displayed on the screen. Grid-shaped dark regions are often displayed on the screen, degrading an image display quality.

As a display screen in a projection system using the aforementioned micromirror array becomes bigger, the power consumption is more likely to increase to a greater extent. Hence, light utilization efficiency needs to be improved to decrease the power consumption.

### DISCLOSURE OF INVENTION

### Technical Problem

Therefore, in order to solve the problem of the related art, one embodiment of the present invention is directed to provide a projection display apparatus advantageous of increasing light utilization efficiency and improving an image display quality using microlens array and micromirror array.

### Technical Solution

To achieve the above advantages, one embodiment of the present invention provides a projection display apparatus using microlens and micromirror arrays, the projection display apparatus comprising a micromirror array comprising at least one micromirror irradiating incident rays as reflection rays by reflecting the incident rays to a predetermined angle, a first microlens array comprising at least one first microlens corresponding to the micromirror and integrating the incident rays onto a reflection surface of the corresponding micromirror, and a second microlens array comprising at least one second microlens corresponding to the micromirror and refracting the reflection rays irradiated from the micromirror as parallel rays.

According to one embodiment of the present invention, the micromirror may reflect the incident rays for displaying one pixel image as reflection rays.

According to one embodiment of the present invention, the first microlens may be irradiated to make the incident rays be integrated as a single point on the reflection surface of the corresponding micromirror.

According to one embodiment of the present invention, the first microlens array and the second microlens array may have substantially the same focal length with respect to the micromirror array.

According to another embodiment of the present invention, the projection display apparatus may further comprise a third microlens array operating a left-right side inversion of the reflection rays irradiated from the micromirror array and projecting the inversed reflection rays to the second microlens array.

According to the other embodiment of the present invention, the third microlens array may be arranged such that a focal point of the third microlens array is disposed in about a half point of a spacing distance between the third microlens array and the second microlens array.

According to another embodiment of the present invention, the projection display apparatus may further comprise an incidence lens projecting the incident rays onto the first microlens array.

According to still another embodiment of the present invention, the projection display apparatus may further comprise a projection lens irradiating the reflection rays that have projected onto the second microlens array onto a predetermined screen.

### Advantageous Effects

Consistent with an exemplary embodiment of the present invention, a projection scheme using microlens array can impede rays of light from reaching the space of the each micromirrors or the regions of the edge portion of the micromirrors, which are inevitably created within a micromirror array in the process of configuring the micromirror array, with an aid of the microlens arrays. Specifically, using one microlens array, incident rays are manipulated to be transmitted to the micromirror array. Thus, light loss that is usually caused by the light transmittance through these regions (or the spaces) can be reduced. Also, light is less likely to be scattered around edge portions of the micromirror array, thereby reducing the light loss. As a result, the reduction of the light loss can lower the power consumption of a projection system.

Rays of light reflected by the micromirror array are changed into parallel rays by another microlens array and then, projected onto a screen. As a result, generation of Grid-shaped dark regions that usually appear on a screen when using a typical projection display apparatus can be eliminated. This elimination of the dark regions can provide a highly qualified smooth image with an improved contrast ratio.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a simplified diagram of a typical projection display apparatus using a micromirror array;

FIG. 2 illustrates a simplified diagram of a projection display apparatus according to an embodiment of the present invention;

FIG. 3 illustrates a light path in the projection display apparatus according to the embodiment of the present invention;

FIG. 4 illustrates a light path in microlens and micromirror arrays according to a first exemplary embodiment of the present invention;

FIG. 5 illustrates a light path in microlens and micromirror arrays according to a second exemplary embodiment of the present invention;

FIG. 6 illustrates a light path in microlens and micromirror arrays according to a third exemplary embodiment of the present invention;

FIG. 7 illustrates a light path in microlens and micromirror arrays according to a fourth exemplary embodiment of the present invention; and

FIG. 8 illustrates a perspective view of microlens and micromirror arrays arranged in three dimensions according to an embodiment of the present invention.

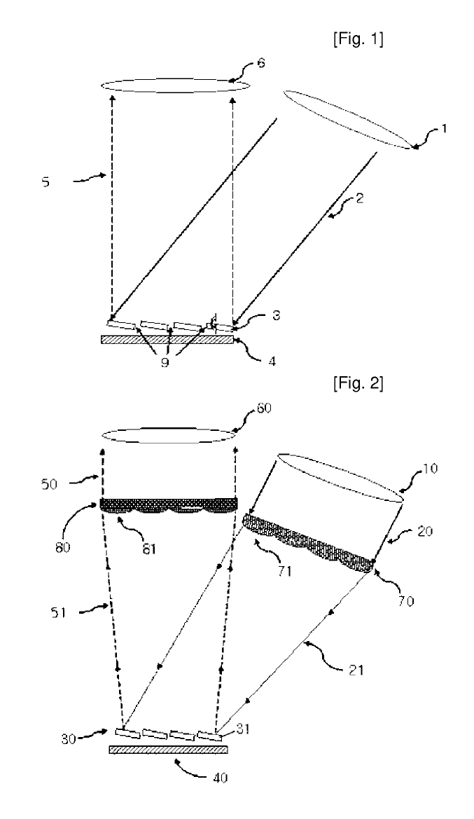

### BEST MODE FOR CARRYING OUT THE INVENTION

It should be noted that like reference numerals denote like elements in different drawings.

FIG. 2 illustrates a simplified diagram of a projection display apparatus according to an embodiment of the present invention. As illustrated in FIG. 2, the projection display apparatus comprises an incidence lens 10, a micromirror array 30, and a projection lens 60. The incidence lens 10 projects first incident rays 20, and the micromirror array 30 reflects the received rays. The projection lens 60 projects first reflection rays 50 that have been reflected from the micromirror array 30 onto a screen. The projection display apparatus further comprises a first microlens array 70 which is interposed in a light path of the first incident rays 20 projected from the incidence lens 10 and converts the first incident rays 20 into the second incident rays 21 condensed per micromirror 31 of the micromirror array 30. The projection display apparatus further comprises a second microlens array 80 which is interposed in a light path of second reflection rays 51 reflected from the micromirror array 30 and converts the second reflection rays 51 transmitted to the projection lens 60 into the first reflection rays 50, which run in parallel.

The micromirror array 30 is disposed over a substrate 40 and comprises multiple micromirrors 31, each corresponding to an individual pixel. Adjusting an operation angle of the individual micromirror 31 allows an adjustment of a reflection angle. On the basis of this fact, an operation angle of each of the micromirrors 31 is adjusted to display an image by adjusting a time to reflect or block rays of light in one pixel corresponding to one micromirror 31.

The first microlens array 70 comprises a predetermined number of first microlenses 71, as many as the micromirrors 31 of the micromirror array 30. The first microlenses 71 condense the first incident rays 20 that have been projected by the incidence lens 10 into the corresponding micromirrors 31 of the micromirror array 30.

The second microlens array 80 comprises a predetermined number of second microlenses 81, as many as the micromirrors 31 of the micromirror array 30. The second microlens array 80 refracts the second reflection rays 51 that have been reflected from the respective micromirrors 31 as parallel rays and subsequently transmit the parallel rays to the projection lens 60.

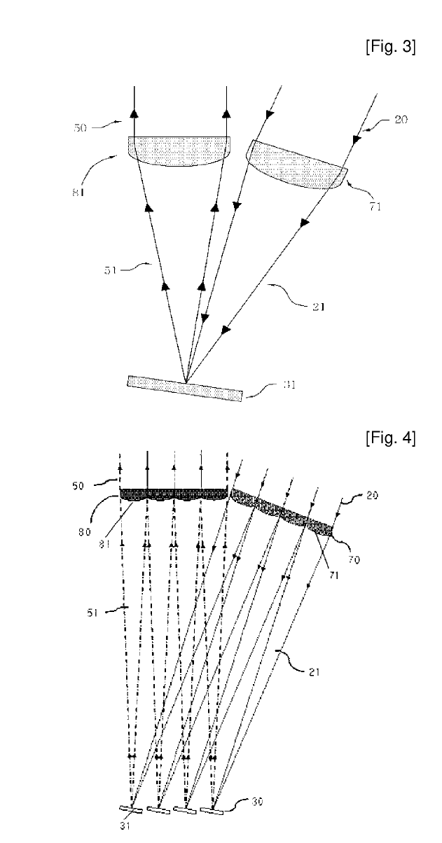

FIG. 3 illustrates a light path of the projection display apparatus according to the embodiment of the present invention. The illustration particularly shows a light path on a pair of microlenses 71 and 81 respectively from the first microlens array 70 and the second microlens array 80 and on one micromirror 31 of the micromirror array 30.

The first microlens 71 condenses the first incident rays 20 into the micromirror 31 and refracts the first incident rays 20 as the second incident rays 21. Afterwards, the first microlens 71 makes the second incident rays 21 be irradiated on a reflection surface of the micromirror 31. Hence, an amount of the second incident rays 21 reaching edge portions of the micromirror 31 can be minimized, and the second incident rays 21 are not allowed to pass through spaces between the adjacent micromirrors 31.

The second microlens 81 refracts the second reflection rays 51 that have been reflected from the micromirror 31 as the first reflection rays 50, which are parallel rays, and then, transmits the first reflection rays 50 to the projection lens 60.

FIG. 4 illustrates a light path in microlens and micromirror arrays according to a first exemplary embodiment of the present invention. Particularly, FIG. 4 illustrates the light path when incident rays are condensed into a single point on individual micromirrors 31.

As illustrated in FIG. 4, a first microlens array 70, which condenses first incident rays 20, and a second microlens array 80, which refracts second reflection rays 51 as parallel rays, are arranged apart in a manner not to block the light path.

The first microlens array 70 condenses the first incident rays 20 into second incident rays 21, each of which subsequently reaches the respective micromirrors 31 of the micromirror array 30 in the form of a single point.

The second reflection rays 51 reflected from the micromirror array 30 are adjusted to first reflection rays 50 that are refracted as parallel rays by the second microlens array 80.

With respect to the micromirror array 30, the first microlens array 70 for the condensation of the first incident rays 20 and the second microlens array 80 for the refraction of the second reflection rays 51 are configured in one pair. The micromirrors 31 and first and second microlenses 71 and 81, which are respective parts of the micromirror array 30 and the first and second microlens arrays 70 and 80, reciprocally correspond to each other, constructing the light path.

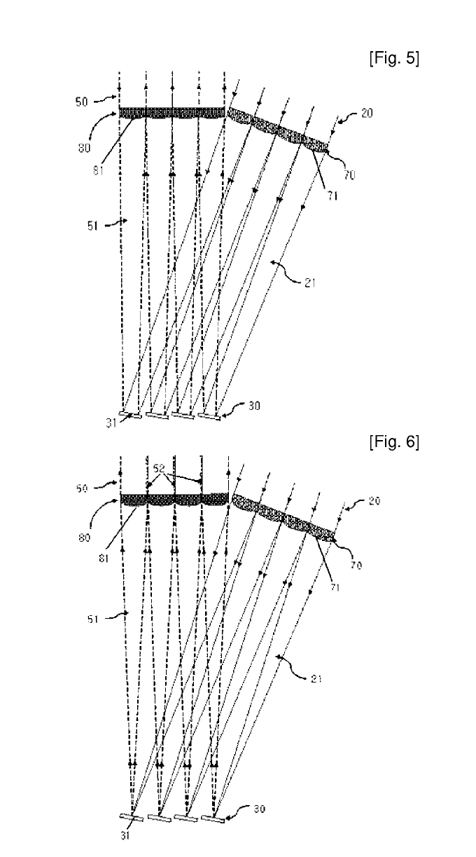

FIG. 5 illustrates a light path in microlens and micromirror arrays according to a second exemplary embodiment of the present invention. Particularly, FIG. 5 illustrates the light path when incident rays are condensed into certain surfaces of micromirrors 31.

As illustrated in FIG. 5, focal lengths generated by a first microlens array 70 are arranged to be longer than a distance to a micromirror array 30. Thus, second incident rays 21 that have passed through the first microlens array 70 are allowed to reach on certain surfaces of the corresponding micromirrors 31.

Adjusting a distance between the first microlens array 70 and the micromirror array 30 allows a point or surface condensation of the second incident rays 21 on the micromirror array 30. More specifically, the condensation form and position of the second incident rays 21 can be controlled by irradiating the second incident rays 21 in a certain form onto the reflection regions of the micromirrors 31 except for those out-of-boundary regions of the micromirrors 31 and edge regions of the micromirrors 31 where rays of light are usually scattered.

FIG. 6 illustrates a light path in microlens and micromirror arrays according to a third exemplary embodiment of the present invention. Particularly, FIG. 6 illustrates a second microlens array 80 arranged to generate overlapping regions 52 between first reflection rays 50 that are transmitted.

As illustrated in FIG. 6, adjusting a distance between the second microlens array 80 and a micromirror array 30 or adjusting a refraction index of the second microlens array 80 causes the first reflection rays 50 that are transmitted through the second microlens array 80 to have the overlapping regions 52 therebetween.

As a result, the generation of the overlapping regions can reduce a usual generation of dark regions on a screen due to the spaces created individually between micromirrors 31 of the micromirror array 30.

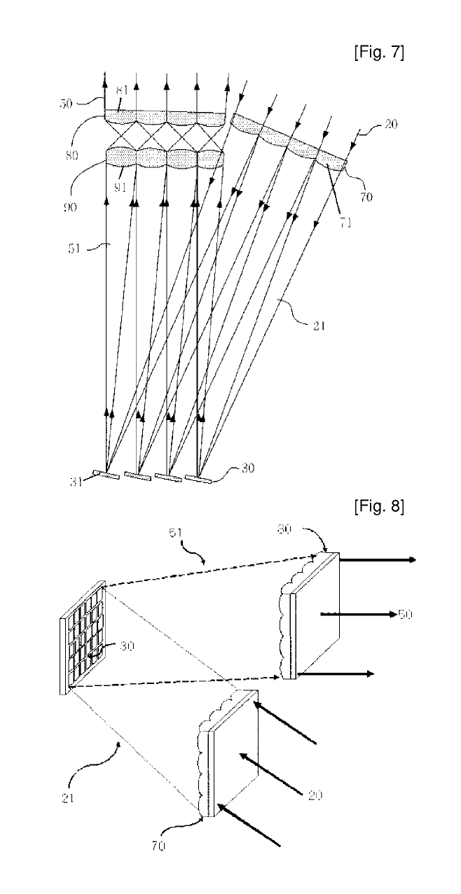

FIG. 7 illustrates a light path in microlens and micromirror arrays according to a fourth exemplary embodiment of the present invention. Particularly, FIG. 7 illustrates an exemplary configuration to prevent an image inversion when an image representing various colors or shapes impinges on one micromirror 31.

As illustrated in FIG. 7, a third lens array 90 having a short focal length is placed in a light path of second reflection rays 51 projected to a second microlens array 80. The second reflection rays 51 are inversed through the third lens array 90 and then, projected in parallel rays through the second microlens array 80.

A first microlens array 70 condenses first incident rays 20 into second incident rays 21, which are subsequently reflected by a micromirror array 30. The second reflection rays 51 resulted from the above reflection by the micromirror array 30 are left and right side inversed with respect to the first incident rays 21. Although not illustrated, when a light source that provides the first and second incident rays 20 irradiates an image with various colors and shapes, the first and second incident rays 20 and 21 corresponding to one pixel can also have certain colors or shapes. When the first and second incident rays 20 and 21 are reflected through the micromirrors 31 of the micromirror array 30, the left and right sides of the first and second incident rays 20 and 21 are inversed. As a result, as the first and second incident rays 20 and 21 are reflected from the individual micromirrors 31, a left-right side inversed pixel image is displayed.

According to the fourth exemplary embodiment of the present invention, the second reflection rays 51 that have been reflected by the micromirror array 30 and left and right side inversed are subjected to again the left-right side inversion executed by the third microlens array 90, which reverts the orientation of the second reflection rays 51 (i.e., left and right sides) as same as that of the original incident rays. Afterwards, the twice inversed second reflection rays 51 transmit through the second microlens array 80, being projecting as parallel rays. As a result, it is possible to prevent the inversion of the image.

Therefore, the third microlens array 90 and the second microlens array 80 are specifically arranged to make a focal point of the third microlens array 90 be disposed in about a half point of a spacing distance between the third microlens array 90 and the second microlens array 80. Thus, the third microlens array 90 can inverse the left and right sides of the second reflection rays 51 that have reflected from the micromirror array 30, and the inversed second reflection rays 51 reach the second microlens array 80 thereafter. Accordingly, it is possible to display a pixel image having substantially the same colors as those of the first and second incident rays 20 and 21 provided from the initial light source (not shown).

Depending on the characteristics of the first and second incident rays 20 and 21 corresponding to one pixel, a high-quality image with improved light efficiency can be displayed using the microlens arrays and the micromirror array according to the first to fourth exemplary embodiments of the present invention. For instance, in the case that an image corresponding to one pixel represents various colors and shapes, the fourth exemplary embodiment, wherein the third microlens array 90 is used to make a left-right side inversion, may be implemented. Also, if an image corresponding to one pixel has a single color and is subjected to a left-right side inversion that does not affect the final orientation (e.g., left and right sides), the microlens arrays and the micromirror array according to the first to fourth exemplary embodiments of the present invention can be implemented.

FIG. 8 illustrates a perspective view of microlens and micromirror arrays in a three-dimensional arrangement according to an embodiment of the present invention.

As illustrated in FIG. 8, a first microlens array 70 and a second microlens array 80 are arranged not to have overlapping light paths depending on the operation angle of a micromirror array 30. The first microlens array 70 comprises a predetermined number of first microlenses 71 which is substantially as many as micromirrors 31 of the micromirror array 30. Also, the second microlens array 80 comprises a predetermined number of second microlenses 81 which is substantially as many as the micromirrors 31.

According to the above configuration, first incident rays 20 are integrated into the second incident rays 21 through the individual first microlenses 71 of the first microlens array 70 and irradiated onto the corresponding micromirrors 31. The second reflection rays 51 that have been reflected from the individual micromirrors 31 are transmitted to the respective second microlenses 81 and then, projected as the first reflection rays 50, which are parallel rays.

In the above arrangement of the micromirror array and the microlens arrays, various parts of a projection system (e.g., color filters and a screen) can be placed in a front portion of the first microlens array 70 and in a rear portion of the second microlens array 80.

Although the projection display apparatus using the microlens and micromirror arrays according to the exemplary embodiments of the present invention is described with reference to the accompanying drawings, the present invention should not construed as being limited to the provided exemplary embodiments and the drawings, and it will be understood by those of ordinary skill in the art that various changes in form and details may be made without departing from the spirit and scope of the present invention.

1. A projection display apparatus using microlens and micromirror arrays, the projection display apparatus comprising:
a micromirror array comprising at least one micromirror irradiating an incident ray as a reflection ray by reflecting the incident ray to a predetermined angle;
a first microlens array comprising at least one first microlens corresponding to the micromirror and condensing the incident ray onto a reflection surface of the corresponding micromirror; and
a second microlens array comprising at least one second microlens corresponding to the micromirror and refracting the reflection ray irradiated from the micromirror as parallel ray.

2. The projection display apparatus of claim 1, wherein the micromirror reflects the incident ray for displaying one pixel image as the reflection ray.

3. The projection display apparatus of claim 1, wherein the first microlens is irradiated to make the incident ray be condensed as a single point on the reflection surface of the corresponding micromirror.

4. The projection display apparatus of claim 1, wherein the first microlens array and the second microlens array have the same focal length with respect to the micromirror array.

5. The projection display apparatus of claim 2, wherein the first microlens array and the second microlens array have the same focal length with respect to the micromirror array.

6. The projection display apparatus of claim 3, wherein the first microlens array and the second microlens array have the same focal length with respect to the micromirror array.

7. The projection display apparatus of claim 1, further comprising a third microlens array operating a left-right side inversion of the reflection ray irradiated from the micromirror array and projecting the inversed reflection ray to the second microlens array.

8. The projection display apparatus of claim 5, wherein the third microlens array is arranged such that a focal point of the third microlens array is disposed in a half point of a spacing distance between the third microlens array and the second microlens array.

9. The projection display apparatus of claim 1, further comprising an incidence lens projecting the incident ray onto the first microlens array.

10. The projection display apparatus of claim 1, further comprising a projection lens irradiating the reflection ray that have projected onto the second microlens array onto a predetermined screen.
